(19) United States
(12) Patent Application Publication
(10) Pub. No.: US 2002/0072931 A1
(43) Pub. Date: Jun. 13, 2002

(54) System and method to provide financial rewards and other incentives to users of personal transaction devices

(76) Inventor: Ronald C. Card, Hayward, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/021,102

(22) Filed: Dec. 5, 2001

Related U.S. Application Data
(60) Provisional application No. 60/254,382, filed on Dec. 7, 2000.

(51) Int. Cl. G06F 17/60

(52) U.S. Cl. 705/1

(57) ABSTRACT

A system and method to provide financial rewards and other incentives to users of personal transaction devices are described. Multiple transactions between a personal transaction device and one or more vendors connected to the personal transaction device are processed. Vendor incentives for each of the vendors and user incentives for a user connected to the personal transaction device are then determined based on each transaction of said plurality of transactions.

### RELATED APPLICATIONS

The present application claims the benefit of U.S. Provisional Patent Application Serial No. 60/254,382, filed on Dec. 7, 2000, and entitled “BUSINESS MODEL TO ESTABLISH FINANCIAL & INCENTIVE RELATIONSHIPS BETWEEN SONY AND OTHERS.”

### FIELD OF THE INVENTION

The present invention relates generally to electronic commerce transactions, and, more particularly, to a system and method to provide financial rewards and other incentives to users of personal transaction devices.

### BACKGROUND OF THE INVENTION

Electronic commerce is achieving widespread use. Transactions are performed everyday over the Internet and through point of sale (POS) or bank systems. As new products are daily introduced into the marketplace, marketing methods are implemented in conjunction with the product launches in order to encourage consumers to buy and use the new products.

Presently, some of the incentives offered to consumers can take the form of monetary awards, for example cash rebates and/or discounts upon purchase of a product, free product awards, encompassing a wide range of products related to the purchased product, and free use of the marketed products in order to induce consumers to purchase the product eventually. However, if a consumer uses a personal transaction device, such as a digital wallet, to purchase a product, the consumer may not have access to the full array of incentives since the supplier of the personal transaction device would not usually also supply the products and/or services that the consumer would purchase. Therefore, what is needed is a method to encourage vendors to provide incentives to consumers that use the personal transaction devices, while at the same time receiving added value for providing the incentives and maintaining the privacy of the consumers.

### SUMMARY OF THE INVENTION

A system and method to provide financial rewards and other incentives to users of personal transaction devices are described. Multiple transactions between a personal transaction device and one or more vendors connected to the personal transaction device are processed. Vendor incentives for each of the vendors and user incentives for a user connected to the personal transaction device are then determined based on each transaction of said plurality of transactions.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 is a block diagram of one embodiment of a system to provide financial rewards and other incentives to users of personal transaction devices.

FIGS. 5A-5B illustrate a flow diagram of one embodiment of a method to provide financial rewards and other incentives to users of personal transaction devices.

FIG. 6 is a block diagram of an exemplary digital processing or computing system in which the present invention can be implemented.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method to provide financial rewards and other incentives to users of personal transaction devices are described in detail below. Multiple transactions between a personal transaction device and one or more vendors connected to the personal transaction device are processed. Vendor incentives for each of the vendors and user incentives for a user connected to the personal transaction device are then determined based on each transaction of said plurality of transactions.

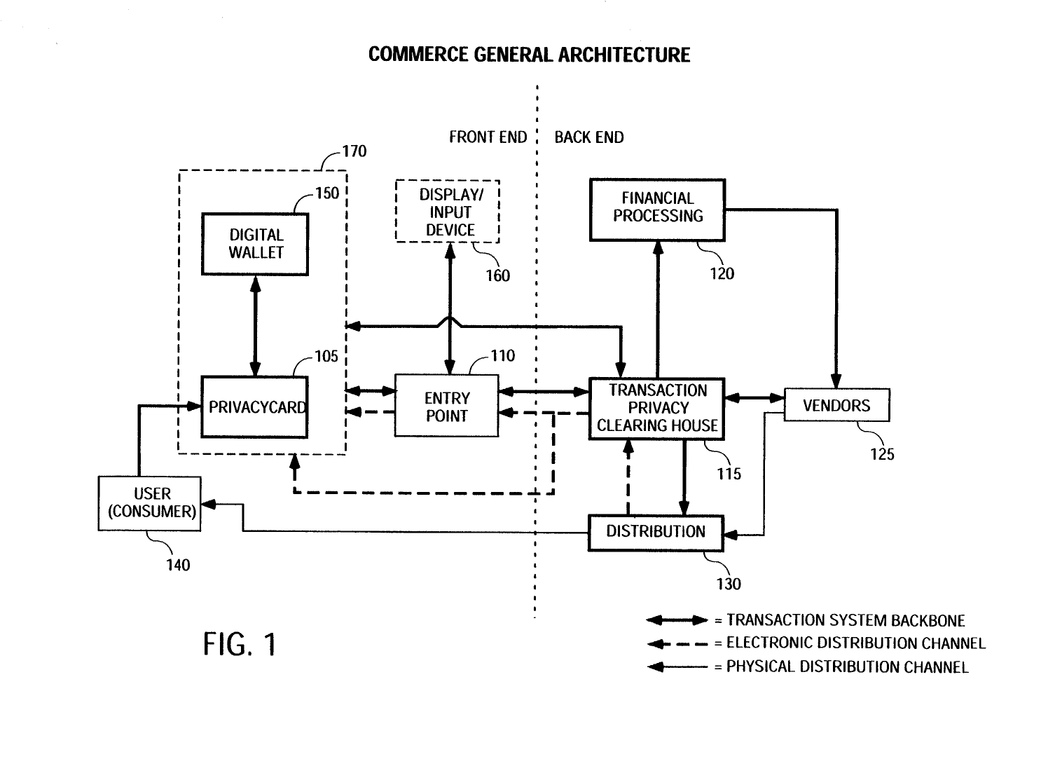

FIG. 1 is a simplified block diagram of one embodiment of a secure transaction system, which may be used in electronic commerce. As illustrated in FIG. 1, in this embodiment, a transaction privacy clearing house (TPCH) 115 interfaces a user (consumer) 140 and a vendor 125. In this particular embodiment, a personal transaction device (PTD) 170, e.g., a privacy card 105, or a privacy card 105 coupled to a digital wallet 150, is used to maintain the privacy of the user while enabling the user to perform transactions. In an alternate embodiment, the PTD 170 may be any suitable device that allows unrestricted access to TPCH 115. The personal transaction device information is provided to the TPCH 115 that then indicates to the vendor 125 and the user 140 approval of the transaction to be performed.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the TPCH 115 contacts the FP 120 and requests a generic credit approval of a particular account. Thus, the FP 120 receives a minimal amount of information. In one embodiment, the transaction information, including the identification of goods being purchased with the credit need not be passed to the FP 120. The TPCH 115 can request the credit using a dummy charge ID that can be listed in the monthly credit statement sent to the user, so that the user can reconcile his credit statement. Further, the personal transaction device 105 can include functionality to cause the credit statement to convert the dummy charge ID back to the transactional information so that the credit statement appears to be a conventional statement that lists the goods that were purchased and the associated amount charged.

A display input device 160 (shown in phantom) may be included to enable the user, or in some embodiments the vendor 125, to display status and provide input regarding the PTD 105 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

The system described herein also provides distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 130 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet are used.

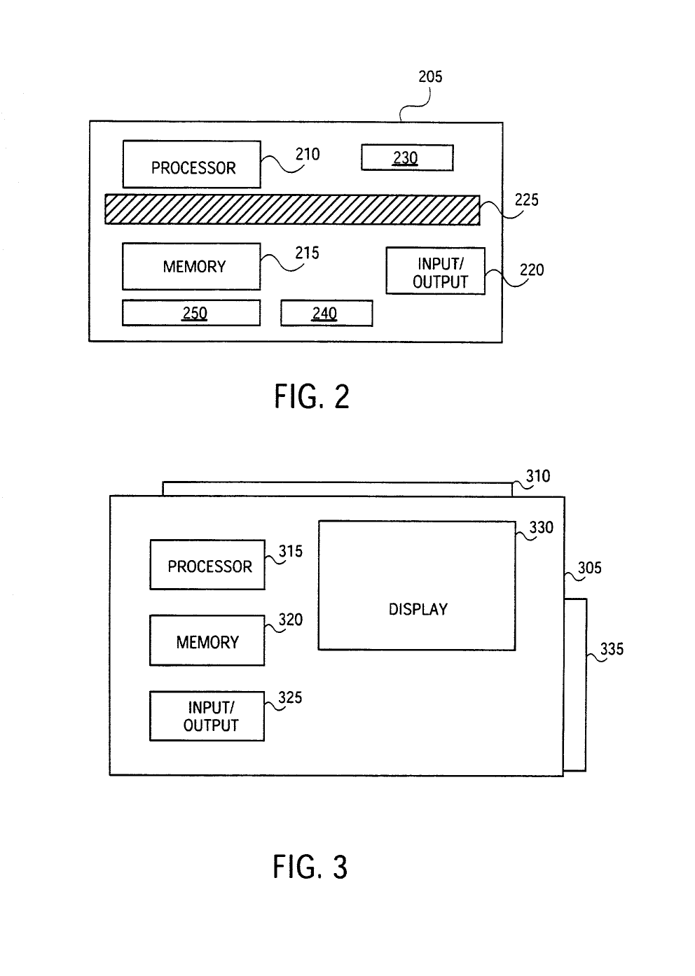

FIG. 2 is a simplified block diagram of one embodiment of a privacy card 205 for a personal transaction device. As illustrated in FIG. 2, in one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function. A suitable biometric control device that may be used is described in U.S. patent application Ser. No. 09/510,811, entitled “Method of Using a Personal Device with Internal Biometric Control in Conducting Transactions Over a Network,” which is herein incorporated by reference.

Memory 215 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

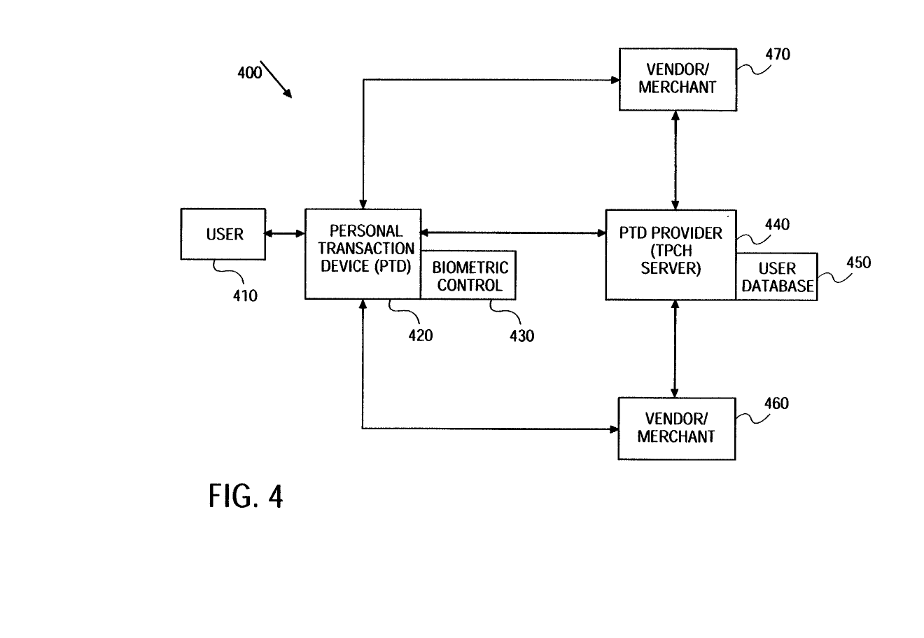

FIG. 3 is a simplified block diagram of one embodiment of a digital wallet 305 for a personal transaction device. As illustrated in FIG. 3, the digital wallet 305 includes a coupling input 310 for the privacy card 205, processor 315, memory 320, input/output logic 225, display 330 and peripheral port 335. The processor 315 is configured to execute instructions, such as those stored in memory 320, to perform the functionality described herein. Memory 320 may also store data including financial information, eCoupons, shopping lists and the like. The digital wallet may be configured to have additional storage. In one embodiment, the additional storage is in a form of a card that couples to the device through peripheral port 310.

In one embodiment, the privacy card 205 couples to the digital wallet 305 through port 310; however, the privacy card 205 may also couple to the digital wallet 305 through another form of connection including a wireless connection.

Input/output logic 325 provides the mechanism for the digital wallet 305 to communicate information. In one embodiment, the input/output logic 325 provides data to a point-of-sale terminal or to the privacy card 205 in a pre-specified format. The data may be output through a wired or wireless connection.

The digital wallet 305 may also include a display 330 for display of status information to the user. The display 330 may also provide requests for input and may be a touch sensitive display, enabling the user to provide the input through the display.

The physical manifestation of many of the technologies in the digital wallet 305 will likely be different from those in the privacy card 205, mainly because of the availability of physical real estate in which to package technology. Examples of different physical representations would include the display, fingerprint recognition unit, etc.

The components of a secure transaction system illustrated in FIGS. 1, 2, and 3 are further described in International Application published under the Patent Cooperation Treaty (PCT), International Publication Number WO 01/52212, filed on Dec. 28, 2000, and entitled “Secure Electronic Commerce System,” which is assigned to the same assignee as the present application and which is hereby incorporated by reference.

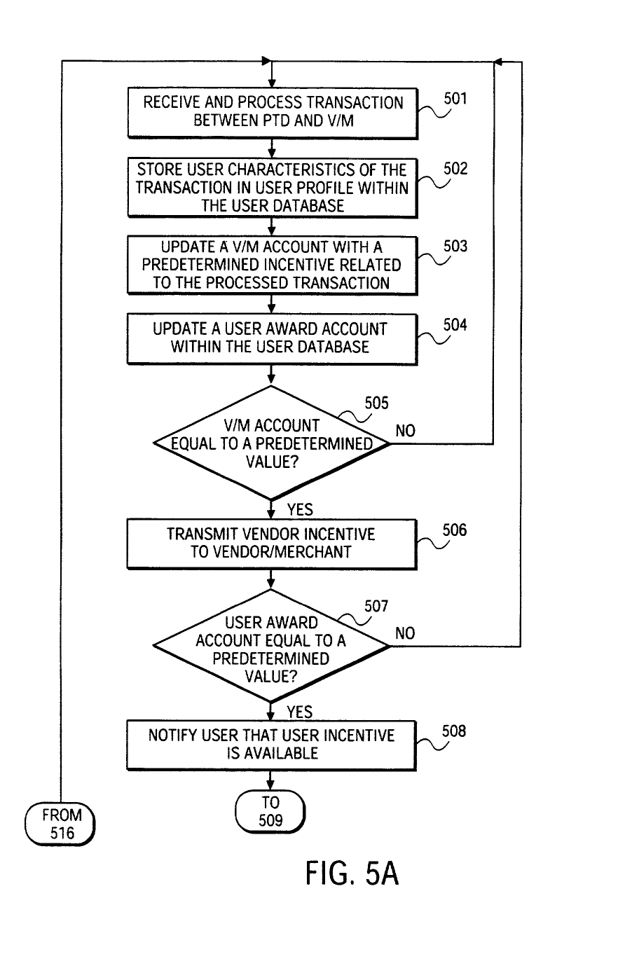

FIG. 4 is a block diagram for one embodiment of a system to provide financial rewards and other incentives to users of personal transaction devices. Referring to FIG. 4, in one embodiment of the system 400, a user 410 communicates with a personal transaction device (PTD) provider 440, for example a TPCH server, via a personal transaction device (PTD) 420. Alternatively, multiple users 410 may be connected to the TPCH server 440 using corresponding PTDs 420. In the embodiment of FIG. 4, the user 410 and the TPCH 440 communicate via a network implemented in a wired or wireless environment. The network may be the Internet, which is a worldwide system of interconnected networks that runs the Internet Protocol (IP) to transfer data, or other types of networks, such as a token ring network, a local area network (LAN), or a wide area network (WAN).

The PTD 420 further includes a biometric control module 430, which allows the PTD 420 to communicate securely with user 410 using biometric information, such as fingerprint recognition. The TPCH server 440 further includes user database 450 containing information related to the user 410, for example a user profile corresponding to the user 410.

In one embodiment, the system 400 further includes one or more vendor/merchants (V/M) 460, 470, connected to the TPCH server 440 and to the PTD 420. In one embodiment, each V/M 460, 470 is a retailer, which provides goods and/or services to the users 410. Alternatively, the V/Ms 460, 470 may be electronic retailers (e-tailers), content and/or service providers, or any other suitable supplier of goods and/or services.

Each V/M 460, 470 is connected to the TPCH server 440 and to the TPD 420 via a network implemented in a wired or wireless environment. The network may be the Internet, which is a worldwide system of interconnected networks that runs the Internet Protocol (IP) to transfer data, or other types of networks, such as a token ring network, a local area network (LAN), or a wide area network (WAN). Alternatively, each V/M 460 or 470 may be connected directly to the PTD 420 via a wired or wireless connection.

In one embodiment, transactions between users 410 and V/Ms 460, 470 via corresponding PTDs 420 are recorded, tracked, and processed by the TPCH server 440. The TPCH server 440 receives each transaction and stores user characteristics related to the transaction in a user profile within the user database 450. In one embodiment, the user characteristics stored in the user profile include purchasing preferences of the user 410. Alternatively, the user characteristics may include financial information related to the user 410 or a transaction history for the user 410. In an alternate embodiment, no user profile is used and the user characteristics are not stored.

Vendor incentives are established between each V/M 460, 470 and the PTD provider 440 to reward vendors and/or merchants that complete transactions with the PTD 420. In one embodiment, the vendor incentives take the form of a fee paid subsequent to each use of the PTD 420 by user 410 to complete a transaction with the V/M 460 or 470. Alternatively, the vendor incentives may be related to a free or reduced rate charged for purchasing information related to the user 410 and requested by the V/M 460 or 470, for example purchasing habits and preferences of the user 410, a list of transactions completed by the user 410, or any other type of information related to the user 410 and available from the TPCH server 440.

User incentives are also established between the PTD 420 and the V/M 460 or 470 to reward the user 410 for completing transactions with the PTD 420. In one embodiment, the V/M 460, 470 gives the user 410 an instant reduction in price, e.g. a rebate, on the completed transaction. Alternatively, the user incentives may take the form of free products and/or services after a number of transactions are completed, or any other known type of consumer incentives.

In one embodiment, the TPCH server 440 stores the vendor incentives and the user incentives in the user database 450. The vendor incentives are tracked using a vendor account (V/M account) within the user database 450. The TPCH server 440 updates the vendor account with a predetermined incentive after each transaction between the respective V/M 460 or 470 and the PTD 420. Similarly, the user incentives are tracked using a user award account within the user database 450. The TPCH server 440 updates the user award account with a predetermined user incentive after the completion of each transaction.

In one embodiment, the TPCH server 440 allocates the vendor incentives and the user incentives without intervention from either the V/M 460, 470 or the user 410. The TPCH server 440 transmits the vendor incentives to the V/M 460 or 470 when the vendor account becomes equal to a predetermined vendor incentive value, for example when the vendor account reaches a specific amount or when a specific number of transactions have been completed. At the same time, the TPCH server 440 notifies the user 410 via the PTD 420 that user incentives are available when the user award account becomes equal to a predetermined user award value, for example when the user award account reaches a specific amount or when a specific number of transactions have been completed. Alternatively, the TPCH server 440 may notify the V/M 460 or 470 at the point-of-sale terminal that user incentives are available for the user 410. In one embodiment, the TPCH server 440 may transmit an incentive list of optional user incentives to the user 410 via PTD 420, for example, a list containing options such as a reduced price for a product, a free product, a cash rebate on the purchase of the product, or any other known incentive that can be applied to the transaction to be performed by the user 410.

In one embodiment, the TPCH server 440 transmits the user incentives automatically to the PTD 420. Alternatively, the TPCH server 440 may tailor the user incentives to the particular user 410 using its corresponding user profile stored within the user database 450. In this embodiment, the TPCH server 440 may retrieve the user profile from the user database 450 and may adapt the user incentives to the purchasing preferences, the financial information, or the transaction history of the user 410. Subsequently, the TPCH server 440 may transmit the tailored user incentives, for example a tailored list of user incentives, to the PTD 420. In another alternate embodiment, the TPCH server 440 may transmit a message to the PTD 420 describing the user incentives for the user 410. The message may prompt the user 410 to select a user incentive from a list of user incentives or may prompt the user 410 to accept or decline the user incentives. After the user 410 makes the selection, the TPCH server 440 receives a reply message containing the user selection from the user 410 via the PTD 420. Responsive to the reply message, the TPCH server 440 transmits the selected user incentive to the PTD 420 or, if the user 410 declined the user incentives, continues the operations described above.

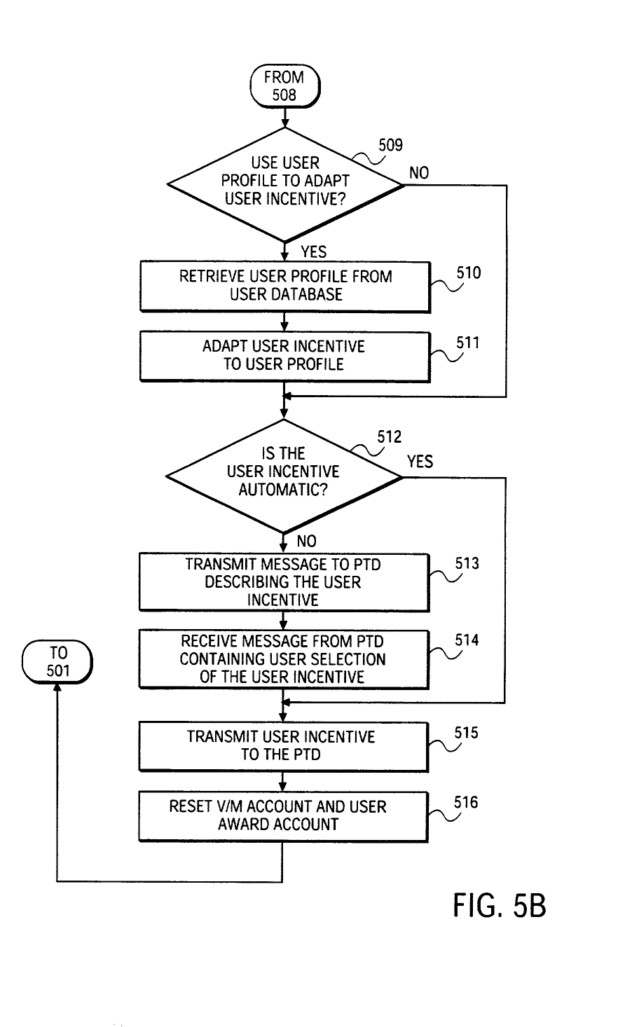

FIGS. 5A-5B illustrate a flow diagram of one embodiment of a method to provide financial rewards and other incentives to users of personal transaction devices. As illustrated in FIG. 5A, at processing block 501, each transaction between the PTD 420 and one or more vendor/merchants (V/M) 460, 470 is received and processed. In one embodiment, after the PTD 420 and the V/M 460 or 470 complete the transaction, the TPCH server 440 receives and processes the completed transaction.

At processing block 502, user characteristics related to the transaction are stored in a user profile within the user database 450. In one embodiment, subsequent to the processing of the transaction, the TPCH server 440 stores user characteristics, which may include purchasing preferences, financial information, and/or a transaction history related to the user 410, in the user profile. Alternatively, the user profile is optional and the TPCH server 440 may not retrieve and store the user characteristics.

At processing block 503, a V/M account is updated with a predetermined incentive related to the processed transaction. In one embodiment, the TPCH server 440 updates the V/M account stored within the user database 450 and pertaining to the respective V/M 460 or 470 with the predetermined vendor incentive.

At processing block 504, a user award account is updated with a predetermined user incentive related to the processed transaction. In one embodiment, the TPCH server 440 updates the user award account stored within the user database 450 and pertaining to the user 410 with the predetermined user incentive.

At processing block 505, a decision is made whether the V/M account is equal to a predetermined value. In one embodiment, the TPCH server 440 examines the V/M account stored within the user database 450 and makes the decision whether the V/M account is equal to the predetermined vendor incentive value. If the V/M account is not equal to the predetermined vendor incentive value, processing blocks 501 through 504 are repeated.

Otherwise, if the V/M account is equal to the predetermined vendor incentive value, at processing block 506, vendor incentives are transmitted to the V/M 460 or 470. In one embodiment, the TPCH server 440 transmits the vendor incentives automatically to the respective V/M 460 or 470.

At processing block 507, a decision is made whether the user award account is equal to a predetermined value. In one embodiment, the TPCH server 440 examines the user award account stored within the user database 450 and makes the decision whether the user award account is equal to a predetermined user award value. If the user award account is not equal to the predetermined user award value, processing blocks 501 through 506 are repeated.

Otherwise, if the user award account is equal to the predetermined user award value, at processing block 508 the user is notified that user incentives are available. In one embodiment, the TPCH server 440 notifies the user 410 via the TPD 420 that the user incentives are available. Alternatively, the TPCH server 440 may notify the V/M 460 or 470 at the point-of-sale terminal that user incentives are available for the user 410.

Referring to FIG. 5B, at processing block 509, a decision is made whether a user profile is used to adapt the user incentives. In one embodiment, the TPCH server 440 decides whether to examine the user profile stored within the user database 450 to tailor the user incentives to the particular user 410. If the TPCH server 440 decides not to use the user profile, the procedure jumps to processing block 512.

Otherwise, if the TPCH server 440 decides to use the user profile, at processing block 510, the user profile is retrieved from the user database 450. In one embodiment, the TPCH server 440 retrieves the user profile from the user database 450.

At processing block 511, user incentives are adapted to the user profile. In one embodiment, the TPCH server 440 examines user characteristics within the user profile, such as purchasing preferences, financial information, and/or a transaction history related to the user 410 and tailors the user incentives to the user profile. For example, the TPCH server 440 may decide to offer a reduction in price for the purchase of a particular item instead of a free gift, if it determines from the user profile that the user 410 prefers reduction in prices instead of free gifts.

At processing block 512, a decision is made whether the user incentive is automatic. In one embodiment, the TPCH server 440 decides whether to send the user incentives directly to the user 410 via the PTD 420 or to allow the user 410 to make predetermined selections. If the user incentive is automatic, the procedure jumps to processing block 515.

Otherwise, if the TPCH server 440 decides to allow the user 410 to make predetermined selections, at processing block 513, a message is transmitted to the PTD 420 describing the user incentives. In one embodiment, the TPCH server 440 transmits a message to the PTD 420, which describes the user incentives pertaining to the user 410. The message may prompt the user 410 to select a user incentive from a list of user incentives or may prompt the user 410 to accept or decline the user incentives.

At processing block 514, a reply message is received from the PTD 420 containing user selection of a user incentive. In one embodiment, after the user 410 makes the selection, the TPCH server 440 receives a reply message containing the user selection from the user 410 via the PTD 420.

At processing block 515, the selected user incentive is transmitted to the PTD 420. In one embodiment, responsive to the reply message, the TPCH server 440 transmits the selected user incentive to the PTD 420.

Finally, at processing block 516, the V/M account and the user award account are reset and processing blocks 501 through 515 are repeated.

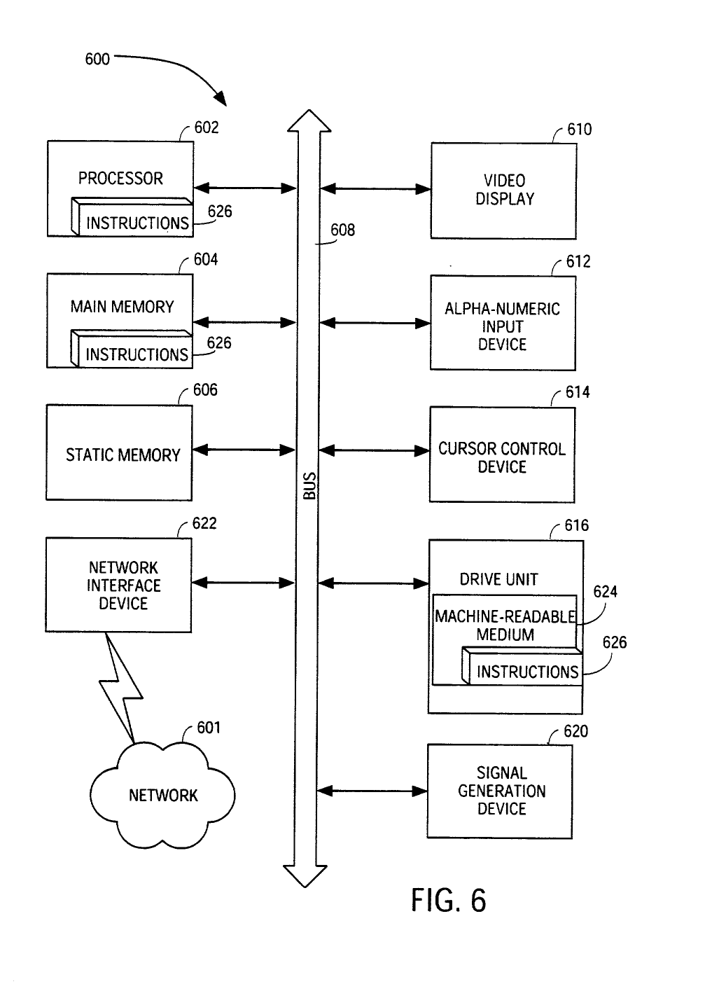

FIG. 6 is a block diagram of an exemplary digital processing or computing system 600 in which the present invention can be implemented. For example, digital processing system 600 can represent the TPCH server 440 or the personal transaction device 420, as described in FIG. 4. Digital processing system 600 may store a set of instructions for causing the system to perform any of the operations described above. Digital processing system 600 can also represent a network device, which includes a network router, switch, bridge, or gateway.

Referring to FIG. 6, digital processing system 600 includes a bus 608 coupled to a central processing unit (CPU) 602, main memory 604, static memory 606, network interface 622, video display 610, alpha-numeric input device 612, cursor control device 614, drive unit 616, and signal generation device 620. The devices coupled to bus 608 can use bus 608 to communicate information or data to each other. Furthermore, the devices of digital processing system 600 are exemplary in which one or more devices can be omitted or added. For example, one or more memory devices can be used for digital processing system 600.

The CPU 602 can process instructions 626 stored either in main memory 604 or in a machine-readable medium 624 within drive unit 616 via bus 608. For one embodiment, CPU 602 can process and execute instructions 626 to implement the operations described above. Bus 608 is a communication medium for communicating data or information for digital processing system 600.

Main memory 604 can be, e.g., a random access memory (RAM) or some other dynamic storage device. Main memory 604 stores instructions 626, which can be used by CPU 602. Main memory 604 may also store temporary variables or other intermediate information during execution of instructions by CPU 602. Static memory 606 can be, e.g., a read only memory (ROM) and/or other static storage devices, for storing information or instructions, which can also be used by CPU 602. Drive unit 616 can be, e.g., a hard or floppy disk drive unit or optical disk drive unit, having a machine-readable medium 624 storing instructions 626. The machine-readable medium 624 can also store other types of information or data.

Video display 610 can be, e.g., a cathode ray tube (CRT) or liquid crystal display (LCD). Video display device 610 displays information or graphics to a user. Alphanumeric input device 612 is an input device (e.g., a keyboard) for communicating information and command selections to digital processing system 600. Cursor control device 614 can be, e.g., a mouse, a trackball, or cursor direction keys, for controlling movement of an object on video display 610. Signal generation device 620 can be, e.g., a speaker or a microphone.

Digital processing system 600 can be connected to a network 601 via a network interface device 622. Network interface 622 can connect to a network such as, for example, a local area network (LAN), wide area network (WAN), token ring network, Internet, or other like networks. Network interface device 622 can also support varying network protocols such as, for example, hypertext transfer protocol (HTTP), asynchronous transfer mode (ATM), fiber distributed data interface (FDDI), frame relay, or other like protocols.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

The invention has been described in conjunction with the preferred embodiment. It is evident that numerous alternatives, modifications, variations and uses will be apparent to those skilled in the art in light of the foregoing description.

What is claimed is:

1. A method comprising:
processing a plurality of transactions between a personal transaction device and at least one vendor connected to said personal transaction device; and
determining vendor incentives for said at least one vendor and user incentives for a user connected to said personal transaction device based on each transaction of said plurality of transactions.

2. The method according to claim 1, wherein said processing further comprises:
receiving each transaction of said plurality of transactions; and
storing a plurality of user characteristics related to said each transaction in a user profile within a user database.

3. The method according to claim 2, wherein said plurality of user characteristics further comprises purchasing preferences of said user.

4. The method according to claim 2, wherein said plurality of user characteristics further comprises financial information related to said user.

5. The method according to claim 2, wherein said plurality of user characteristics further comprises a transaction history of said user.

6. The method according to claim 1, further comprising:
updating a vendor account within a user database with a predetermined incentive related to said each transaction of said plurality of transactions; and
updating a user award account within said user database with a predetermined user incentive after said each transaction is processed.

7. The method according to claim 6, wherein said predetermined incentive is a fee paid subsequent to each use of said personal transaction device to complete said each transaction.

8. The method according to claim 6, wherein said predetermined incentive is a rate charged for purchasing information related to said user and requested by said at least one vendor.

9. The method according to claim 6, wherein said predetermined incentive is a rate charged for advertising.

10. The method according to claim 1, further comprising:
transmitting said vendor incentives to said at least one vendor, if a vendor account stored within a user database and containing said vendor incentives is equal to a predetermined vendor incentive value.

11. The method according to claim 1, further comprising:
notifying said user through said personal transaction device that said user incentives are available, if a user award account stored within a user database and containing said user incentives is equal to a predetermined user award value.

12. The method according to claim 11,further comprising:
retrieving a user profile from said user database;
adapting said user incentives to said user profile; and
transmitting said user incentives to said personal transaction device.

13. The method according to claim 11, further comprising automatically transmitting said user incentives to said personal transaction device.

14. The method according to claim 11, further comprising:
transmitting a message to said personal transaction device describing said user incentives;
receiving a reply message from said personal transaction device, said reply message containing a selection of a selected user incentive of said user incentives; and
transmitting said selected user incentive to said personal transaction device.

15. The method according to claim 14, wherein said message prompts said user to select said selected user incentive from an incentive list containing said user incentives.

16. The method according to claim 14, wherein said message prompts said user to select or decline receipt of said user incentives.

17. The method according to claim 1, further comprising:
transmitting an incentive list containing said user incentives to said personal transaction device;
receiving a selection of a selected user incentive from said personal transaction device; and
transmitting said selected user incentive to said personal transaction device.

18. The method according to claim 1, further comprising:
notifying said at least one vendor that said user incentives are available, if a user award account stored within a user database and containing said user incentives is equal to a predetermined user award value.

19. An apparatus comprising:
means for processing a plurality of transactions between a personal transaction device and at least one vendor connected to said personal transaction device; and
means for determining vendor incentives for said at least one vendor and user incentives for a user connected to said personal transaction device based on each transaction of said plurality of transactions.

20. The apparatus according to claim 19, further comprising:
means for receiving each transaction of said plurality of transactions; and storing a plurality of user characteristics related to said each transaction in a user profile within a user database.

21. The apparatus according to claim 19, further comprising:
means for updating a vendor account within a user database with a predetermined incentive related to said each transaction of said plurality of transactions; and
means for updating a user award account within said user database with a predetermined user incentive after said each transaction is processed.

22. The apparatus according to claim 19, further comprising:
means for transmitting said vendor incentives to said at least one vendor, if a vendor account stored within a user database and containing said vendor incentives is equal to a predetermined vendor incentive value.

23. The apparatus according to claim 19, further comprising:
means for notifying said user through said personal transaction device that said user incentives are available, if a user award account stored within a user database and containing said user incentives is equal to a predetermined user award value.

24. The apparatus according to claim 23,further comprising:
means for retrieving a user profile from said user database;
means for adapting said user incentives to said user profile; and
means for transmitting said user incentives to said personal transaction device.

25. The apparatus according to claim 23, further comprising means for automatically transmitting said user incentives to said personal transaction device.

26. The apparatus according to claim 23, further comprising:
means for transmitting a message to said personal transaction device describing said user incentives;
means for receiving a reply message from said personal transaction device, said reply message containing a selection of a selected user incentive of said user incentives; and
means for transmitting said selected user incentive to said personal transaction device.

27. The apparatus according to claim 26, wherein said message prompts said user to select said selected user incentive from an incentive list containing said user incentives.

28. The apparatus according to claim 26, wherein said message prompts said user to select or decline receipt of said user incentives.

29. The apparatus according to claim 19, further comprising:
means for transmitting an incentive list containing said user incentives to said personal transaction device;
means for receiving a selection of a selected user incentive from said personal transaction device; and
means for transmitting said selected user incentive to said personal transaction device.

30. The apparatus according to claim 19, further comprising:
means for notifying said at least one vendor that said user incentives are available, if a user award account stored within a user database and containing said user incentives is equal to a predetermined user award value.

31. A machine readable medium containing executable instructions, which, when executed in a processing system, cause said processing system to perform a method comprising:
processing a plurality of transactions between a personal transaction device and at least one vendor connected to said personal transaction device; and
determining vendor incentives for said at least one vendor and user incentives for a user connected to said personal transaction device based on each transaction of said plurality of transactions.

32. The machine readable medium according to claim 31, wherein said method further comprises:
receiving each transaction of said plurality of transactions; and storing a plurality of user characteristics related to said each transaction in a user profile within a user database.

33. The machine readable medium according to claim 31, wherein said method further comprises:
updating a vendor account within a user database with a predetermined incentive related to said each transaction of said plurality of transactions; and
updating a user award account within said user database with a predetermined user incentive after said each transaction is processed.

34. The machine readable medium according to claim 31, wherein said method further comprises:
transmitting said vendor incentives to said at least one vendor, if a vendor account stored within a user database and containing said vendor incentives is equal to a predetermined vendor incentive value.

35. The machine readable medium according to claim 31, wherein said method further comprises:
notifying said user through said personal transaction device that said user incentives are available, if a user award account stored within a user database and containing said user incentives is equal to a predetermined user award value.

36. The machine readable medium according to claim 35,wherein said method further comprises:
retrieving a user profile from said user database;
adapting said user incentives to said user profile; and
transmitting said user incentives to said personal transaction device.

37. The machine readable medium according to claim 35, wherein said method further comprises automatically transmitting said user incentives to said personal transaction device.

38. The machine readable medium according to claim 35, wherein said method further comprises:
transmitting a message to said personal transaction device describing said user incentives;
receiving a reply message from said personal transaction device, said reply message containing a selection of a selected user incentive of said user incentives; and
transmitting said selected user incentive to said personal transaction device.

39. The machine readable medium according to claim 38, wherein said message prompts said user to select said selected user incentive from an incentive list containing said user incentives.

40. The machine readable medium according to claim 38, wherein said message prompts said user to select or decline receipt of said user incentives.

41. The machine readable medium according to claim 31, wherein said method further comprises:
transmitting an incentive list containing said user incentives to said personal transaction device;
receiving a selection of a selected user incentive from said personal transaction device; and
transmitting said selected user incentive to said personal transaction device.

42. The machine readable medium according to claim 31, wherein said method further comprises:
notifying said at least one vendor that said user incentives are available, if a user award account stored within a user database and containing said user incentives is equal to a predetermined user award value.

43. A system comprising:
a personal transaction device connected to a user; and
a server connected to said personal transaction device and at least one vendor to process a plurality of transactions between said personal transaction device and said at least one vendor and to determine vendor incentives for said at least one vendor and user incentives for said user based on each transaction of said plurality of transactions.

44. The system according to claim 43, wherein said server further receives each transaction of said plurality of transactions and stores a plurality of user characteristics related to said each transaction in a user profile within a user database.

45. The system according to claim 44, wherein said plurality of user characteristics further comprises purchasing preferences of said user.

46. The system according to claim 44, wherein said plurality of user characteristics further comprises financial information related to said user.

47. The system according to claim 44, wherein said plurality of user characteristics further comprises a transaction history of said user.

48. The system according to claim 43, wherein said server further
updates a vendor account within a user database with a predetermined incentive related to said each transaction of said plurality of transactions; and
updates a user award account within said user database with a predetermined user incentive after said each transaction is processed.

49. The system according to claim 48, wherein said predetermined incentive is a fee paid subsequent to each use of said personal transaction device to complete said each transaction.

50. The system according to claim 48, wherein said predetermined incentive is a rate charged for purchasing information related to said user and requested by said at least one vendor.

51. The system according to claim 48, wherein said predetermined incentive is a rate charged for advertising.

52. The system according to claim 43, wherein said server further
transmits said vendor incentives to said at least one vendor, if a vendor account stored within a user database and containing said vendor incentives is equal to a predetermined vendor incentive value.

53. The system according to claim 43, wherein said server further
notifies said user through said personal transaction device that said user incentives are available, if a user award account stored within a user database and containing said user incentives is equal to a predetermined user award value.

54. The system according to claim 53, wherein said server further
retrieves a user profile from said user database;
adapts said user incentives to said user profile; and
transmits said user incentives to said personal transaction device.

55. The system according to claim 53, wherein said server automatically transmits said user incentives to said personal transaction device.

56. The system according to claim 43, wherein said server further
transmits a message to said personal transaction device describing said user incentives;
receives a reply message from said personal transaction device, said reply message containing a selection of a selected user incentive of said user incentives; and
transmits said selected user incentive to said personal transaction device.

57. The system according to claim 56, wherein said message prompts said user to select said selected user incentive from an incentive list containing said user incentives.

58. The system according to claim 56, wherein said message prompts said user to select or decline receipt of said user incentives.

59. The system according to claim 43, wherein said server further
transmits an incentive list containing said user incentives to said personal transaction device;
receives a selection of a selected user incentive from said personal transaction device; and
transmits said selected user incentive to said personal transaction device.

60. The system according to claim 43, wherein said server further
notifies said at least one vendor that said user incentives are available, if a user award account stored within a user database and containing said user incentives is equal to a predetermined user award value.
